(19) United States
(12) Patent Application Publication
(10) Pub. No.: US 2002/0060128 A1
(43) Pub. Date: May 23, 2002

(54) METHOD OF AND APPARATUS FOR REMOVING SELECTED STACKS OF SUPERIMPOSED SHEETS FROM A CONVEYOR

(76) Inventor: WOLFRAM WOLF, BILSEN (DE)

Correspondence Address: VENABLE, 1201 NEW YORK AVENUE NW, WASHINGTON, DC, 200053917

(21) Appl. No.: 09/437,210

(22) Filed: Nov. 10, 1999

(30) Foreign Application Priority Data
Nov. 10, 1998 (DE) 198 51 780.7

(51) Int. Cl. B65G 1/00

(52) U.S. Cl. 198/347.3

(57) ABSTRACT

Selected individual stacks or selected groups of two or more successive stacks of paper sheets or the like are transferred sideways from a predetermined portion of a stack-supplying conveyor onto a facility employing one or more air cushion tables, or across the facility onto a second conveyor, in such a way that the transfer involves only a short-lasting interruption of advancement of stacks toward and in the predetermined portion of the stack-supplying conveyor, namely for an interval which is required to transfer the selected stack(s) from the predetermined portion of the stack-supplying conveyor onto the facility. This is accomplished by employing a stack evacuating system which is movable transversely of the conveyor or conveyors and of the facility and employs one or more flaps or other suitable transfer members pivotable or otherwise movable (a) downwardly to engage the side face(s) of the selected stack(s) for transfer from the predetermined portion of the stack-supplying conveyor onto or into the facility or onto the second conveyor and (b) upwardly and to a level above the stacks for return movement to a starting position.

### BACKGROUND OF THE INVENTION

The invention relates to improvements in methods of and in apparatus for manipulating substantially block-shaped commodities, such as stacks or piles of superimposed sheets of paper, cardboard, plastic, metallic foil or the like. More particularly, the invention relates to improvements in methods of and in apparatus for evacuating or transferring selected individual commodities (hereinafter called stacks for short) from a selected portion of a path which is defined by a belt or chain conveyor or other suitable conveying means for a series of successive stacks. Still more particularly, the invention relates to improvements in methods of and in apparatus for transferring stacks from a selected portion of a conveyor into or onto a facility for temporary storage of stacks or across such facility and onto or into a second conveyor which delivers the thus received stack or stacks back to the first mentioned conveyor, to storage or to a processing station, e.g., to a station where the stacks are confined in envelopes of paper or the like.

It is customary to subdivide individual large panels or sheets of paper (e.g., bond paper or copying paper), or a continuous web of paper, into sheets of a desired size or shape and to accumulate such sheets into piles or stacks, e.g., into so-called reams of 500 sheets each. The machine which assembles such stacks is known as a sheeter. Each such sheeter comprises one or more cutters which severs or sever the panels or the web longitudinally and/or transversely, depending on the size of the starting material, i.e., of the aforementioned large panels or webs.

The stacks are delivered to one or more conveyors, e.g., belt or chain conveyors which transports or transport elongated series or files of stacks to storage or to a further processing station, e.g., to a wrapping machine. The conveyor or conveyors must deliver successive stacks at a high frequency, especially in a modern paper making and processing plant wherein each sheeter can turn huge numbers of stacks per unit of time. Each conveyor must be capable of transporting stacks of superimposed sheets at the required frequency when the associated sheeter or sheeters operate at full capacity, and such conveyor or conveyors must also be capable of permitting removal of certain numbers or percentages of stacks when the machine or machines receiving the stacks operates or operate at less than full capacity or are brought to a temporary halt for the purposes of inspection, maintenance, repair and/or any other reason or reasons.

A drawback of presently known production lines wherein one or more sheeters deliver stacks of sheets to one or more wrapping machines is that, in many instances, the capacity of a modern sheeter exceeds the requirements of a wrapping machine. Therefore, it is necessary to divide the output of a sheeter by diverting a certain percentage of stacks from the path wherein a series of stacks is caused to advance from the sheeter to an associated wrapping machine. In fact, it is often necessary to split up the output of a sheeter for delivery to more than two packing machines. This necessitates the establishment of a pattern according to which certain stacks are diverted from the path leading from a high-capacity sheeter to a first packing machine, and to provide one or more conveyors which accept the diverted stacks for delivery to one or more additional packing machines. Diversion can involve expulsion or evacuation of individual stacks or simultaneous evacuation of two or more successive stacks.

Similar undertakings are being resorted to when the speed of a packing machine must be reduced for the purposes of inspection, repair and/or for other purposes. For example, if a sheeter is designed to normally deliver stacks to two packing machines and one of the packing machines must be brought to a halt, the other packing machine must take up the entire output of the sheeter or a certain number of stacks must be temporarily stored for future transfer to one of the two packing machines or to both packing machines; this might become necessary in the event of temporary stoppage or slowdown of the sheeter.

The apparatus which are utilized to divert sheets from a path leading from a sheeter to a packing machine, e.g., for delivery to a second packing machine, must be capable of diverting individual stacks or series of two or more successive stacks at a very high speed and in such away that they do not affect (or do not unduly affect) the rate of delivery of stacks to the functioning packing machine. The present invention aims to improve such apparatus, i.e., to ensure that the diversion of larger or smaller numbers of stacks from a path leading from a sheeter or an analogous source to a packing machine or another consumer will not unduly affect the delivery of remaining stacks to the consumer.

German patent No. 44 15 047 A1 discloses an apparatus which employs a first belt conveyor defining a first path that extends from a sheeter to a packing machine, and a second belt conveyor which defines a second path parallel to the first path. Each conveyor comprises at least one speed reducing and at least one accelerating section; such conveyors render it possible to change the spacing between neighboring stacks, e.g., to establish clearances between stacks which abut each other on their way from the outlet of the sheeter. The apparatus which is disclosed in the German patent further comprises additional (third) conveyors which extend diagonally of the first and second conveyors and serve to transfer stacks from the belt conveyor leading to a slowed-down or arrested packing machine to the other belt conveyor.

A drawback of the just described patented apparatus is that the transport of stacks by the third conveyors involves a change of orientation of the stacks and the generation of forces tending to affect the appearance of the stacks, namely the accuracy of overlap of sheets in the stacks which are being transported between the two belt conveyors. The situation is aggravated due to the high speed at which the stacks are being advanced by the belt conveyors as well as by the diagonal conveyors. In fact, it is often impossible to wrap a stack which has been subjected to the just discussed forces as a result of travel from the first belt conveyor to the second belt conveyor along the path or paths defined by the third conveyors.

Another apparatus is disclosed in German patent No. 44 21 325 A1. This apparatus employs a conveyor for stacks leading from a sheeter to a stack processing machine as well as several pushers which are set up to shift stacks from the conveyor to temporary storage when the consuming machine cannot accept the entire output of the sheeter. A drawback of such apparatus is that the pushers interrupt the transport of stacks by the conveyor for long intervals of time during as well as following the transfer of stacks to temporary storage. Moreover, the storage facilities are complex, expensive and occupy a substantial amount of space. The same holds true for the pushers and for the means for supporting, moving and guiding the pushers.

Published German patent application Serial No. 27 08 131 discloses an apparatus which is analogous to the apparatus disclosed in the aforediscussed German patent No. 44 15 047 A1 except that the diagonally extending third conveyors are replaced by rails for pallets which transport stacks between the first and second conveyors. Switches are provided to direct stacks from the first path onto the pallets and to effect the transfer of stacks from the pallets onto the second conveyor. Such apparatus exhibit the drawback that the rails, pallets and switches contribute to the cost, complexity and bulk of the apparatus. This holds especially true for the pallets which must be specifically designed to carry out the stack-receiving, transporting and discharging functions.

Of course, presently known apparatus of the aforedescribed character are not utilized or designed solely for the purpose of transporting stacks from a single maker (such as a sheeter) to one or more consumers (such as packing machines) and of diverting stacks from a first path into at least one second path if the single consumer or one of several consumers cannot accept the expected share of stacks. For example, if an apparatus is to deliver stacks from a sheeter to a single packing machine, such apparatus can be provided with means for diverting certain stacks, or for temporarily diverting all oncoming stacks, from the path leading from the single sheeter to the single packing machine (e.g., due to a breakdown or a slowdown of the packing machine). Moreover, it is often necessary to monitor the quality of successive stacks and to provide an apparatus which can expel or otherwise remove defective stacks from the path serving to lead satisfactory stacks to a processing machine. Such apparatus, too, must be designed by taking into consideration the very high speed (i.e., the very large output) of modern sheeters and the sensitivity of stacks of paper sheets to deformation as a result of an abrupt deceleration, acceleration and/or change of direction of movement away from the outlet of a modern sheeter or another suitable stack producing machine. It is especially important to ensure that the expulsion or withdrawal of certain stacks from the path leading from the outlet of a maker does not interfere with the transport of the remaining stacks to their anticipated destination (such as a packing machine) or that the duration of interference is as short as possible.

U.S. Pat. No. 3,822,777 (granted Jul. 9, 1974 to Jepsen for “JUNCTION SWITCH FOR CONVEYING SYSTEMS”) discloses a conveyor system for bundles of papers and a pusher which is actuatable to shift a neighboring stack or bundle off the conveyor system onto the belt of a second conveyor system. A drawback of the patented apparatus is that the pusher interferes with forward movement of bundles during expulsion off the conveyor system as well as during return movement back to a starting position. This can result in the development of large pileups of bundles upstream of the pusher, especially if the bundles are supplied by a high-speed maker or assembler of bundles.

German patent No. 34 03 215 A1 discloses an apparatus which is designed to expel certain stacks of paper sheets or the like off a first conveyor by a second conveyor which extends transversely of the path defined by and is installed at a level above the first conveyor. The second conveyor can be lowered into motion transmitting engagement with the top portion of a selected stack which is to be removed from the first conveyor and, at the same time, rollers are raised above the path which is defined by the first conveyor. The rollers engage the selected stack from below and lift such stack sufficiently to reduce or terminate frictional engagement with the first conveyor. Thus, the stack which is to be moved off the first conveyor is compressed between the lowered second conveyor and the raised rollers. Such apparatus reduces the likelihood of shifting of certain sheets relative to the other sheets of a stack which is being transported off the first conveyor, and the second conveyor is capable of ensuring that a selected stack can be moved off the first conveyor exactly at a selected speed (i.e., at the speed of the second conveyor).

However, the just described patented apparatus also exhibits numerous serious drawbacks. Thus, not only the rollers but also the second conveyor must engage the adjacent portions of a selected stack with a considerable force, and this is likely to entail undesirable deformation of one or more sheets at the top and/or at the bottom of the selected stack. Even if the deformation is of a short-lasting nature, the second conveyor and/or the rollers is or are likely to deface the adjacent sheet or sheets which (at least in many instances) necessitates discarding of the respective stack, i.e., expulsion of such stack from the locus of deposition of stacks which were removed from the first conveyor by the second conveyor in cooperation with the aforementioned rollers. Still further, the second conveyor prevents the first conveyor from advancing stacks toward and past the rollers during actual removal of one or more selected stacks as well as during return movement of the second (overhead) conveyor to its starting position. In other words, the transport of stacks by the first conveyor toward and beyond the second conveyor is interrupted not only during actual transfer of one or more stacks off the first conveyor but also during a certain interval following the completion of the actual expelling or removing operation.

The aforementioned U.S. Pat. No. 3,822,777 discloses an air cushion table which can establish an air cushion above the upper side of a panel serving to support a bundle of paper sheets or the like. A somewhat similar air cushion table is disclosed in German patent No. 24 49 620 C2 wherein the escape of air from ports or analogous openings in the top surface of a panel is controlled by elongated valving elements. A somewhat similar air cushion table (but with spherical valving elements) is disclosed in German patent No. 31 22 632 A1.

A drawback of conventional air cushion tables is that they must be provided with one or more sources of highly compressed air in order to cause the valving elements to interrupt the outflow of air through the respective ports, i.e., to break up the air cushion for one or more stacks, piles or bundles of superimposed sheets above the top surface of the panel. In fact, the required pressure of the air is often so high that compressed air is likely or bound to damage certain sheets of a stack on such conventional air cushion table.

### OBJECTS OF THE INVENTION

An object of the invention is to provide an apparatus which can manipulate block-shaped commodities (such as stacks, piles or bundles of sheets made of paper, metal and/or a plastic material) while the commodities are in the process of advancing from a source (e.g., a sheeter or another suitable maker or assembler of sheets) to one or more processing stations, e.g., to or or more machines which are designed to confine reams of paper sheets in wrapping paper preparatory to baling, crating, boxing or other treatment, and which can manipulate the commodities more reliably and more predictably than heretofore known apparatus.

Another object of the invention is to provide an apparatus which can treat commodities in the form of stacked or baled sheets gently so that none of the sheets are likely to be deformed and/or contaminated as a result of treatment in and/or by the improved apparatus.

A further object of the invention is to provide the apparatus with novel and improved means for diverting one or more selected stacks from a path leading from the outlet of a maker to the inlet of a processing machine or unit in such a way that each diversion involves a surprisingly short-lasting interruption of advancement of stacks from the maker.

An additional object of the invention is to provide the apparatus with novel and improved means for accepting, temporarily storing and making available stacks which must be diverted from their normal path due to malfunctioning, low capacity, reduced capacity and/or other problems with the intended processing machine or machines.

Still another object of the invention is to provide an apparatus which can be utilized in conjunction with presently known makers of stacks of superimposed sheets including makers capable of turning out stacks at a rate greatly exceeding the capacity of presently known machines or units for processing the stacks preparatory to storage or shipment.

A further object of the invention is to provide an apparatus the reliability of which is not affected by the number of stacks which must be expelled or otherwise removed from their customary path, i.e., which can expel individual stacks just as reliably as rows or files of two or more successive abutting or spaced-apart stacks.

Another object of the invention is to provide an apparatus which can be utilized as a superior substitute for presently known and used apparatus serving to manipulate block-shaped commodities in the form of stacks, piles, bales and/or other accumulations of sheets made of paper, cardboard, metal, plastic or the like.

An additional object of the invention is to provide the above outlined apparatus with one or more novel and improved conveyors for reliable transport, guidance and temporary storage of series of abutting or spaced apart block-shaped commodities, e.g., stacks of superimposed paper sheets issuing from a sheeter or another suitable maker.

Still another object of the invention is to provide an apparatus which can operate highly satisfactorily even though it need not employ rails, specially designed pallets, specially designed switching systems, sheet-engaging rollers and/or other constituents which are utilized in standard apparatus and contribute to the bulk, cost, complexity and unreliability of the standard apparatus.

A further object of the invention is to provide the above outlined apparatus with means for evacuating defective commodities with the same facility as superfluous commodities and wherein the expelling or evacuating means is constructed, assembled and operated in a manner to occupy a small amount of space, to occupy space which is normally available between a maker and one or more processors of stacks of paper sheets or the like, and to treat the commodities gently but firmly to ensure that each of a short or long series of diverted commodities can reach its destination in the desired manner and without any damage (such as tearing, creasing, smudging, puncturing and/or misaligning) to its constituents.

Another object of the invention is to provide an apparatus having stack evacuating means which is designed in such away that the stacks which are to be manipulated thereby need not and are not subjected to pronounced mechanical and/or other stresses (such as those applied by a highly compressed gaseous fluid) and the absence of such stresses does not adversely affect the quality of treatment.

An additional object of the invention is to provide one or more novel and improved air cushion tables which can be utilized in the conveyor (s) and/or elsewhere in an apparatus of the above outlined character.

An ancillary object of the invention is to design the air cushion table or tables in such a way that the air cushion or cushions are established in automatic response to the development of need therefor, e.g., for reception of block-shaped commodities and/or for transfer of commodities from the table or tables onto one or more conveyors or the like.

Still another object of the invention is to provide a novel and improved method of manipulating commodities, such as stacks of superimposed sheets of paper, cardboard, foil or the like, especially between a sheeter or another source of stacks and one or more processing units, such as wrapping machines for reams of sheets of bond paper, copy paper or the like.

A further object of the invention is to provide a method which renders it possible to carry out the evacuation of stacks of paper sheets from their prescribed path with a dispatch which cannot be achieved by resorting to heretofore known methods and which can be practiced by resorting to relatively simple, compact and inexpensive but highly reliable, long-lasting and readibly automatable apparatus.

Another object of the invention is to provide a method which renders it possible to achieve the afore-enumerated objects by resorting to a surprisingly small number of simple steps which suffice to avoid the drawbacks of heretofore known methods.

An additional object of the invention is to provide a method of expelling or otherwise removing one or more selected block-shaped commodities from the prescribed path for a sucession of contacting or spaced-apart commodities in such a way that the transport of commodities in the entire prescribed path can be resumed immediately upon completion of expulsion or evacuation of the selected commodity or commodities from the prescribed path onto a conveyor, an air cushion table or elsewhere.

Still another object of the invention is to provide a method which renders it possible to expel or otherwise evacuate from their prescribed path successive discrete commodities or groups of two or more successive commodities in rapid sequence irrespective of the speed of the commodities in their prescribed path, e.g., from a maker to one or more processing units.

### SUMMARY OF THE INVENTION

One of several important features of the present invention resides in the provision of an apparatus for manipulating substantially block-shaped commodities. The improved apparatus comprises at least one means for conveying a series of commodities in a predetermined direction along a predetermined path (e.g., along a straight horizontal path) wherein the commodities have sides (normally their upper sides) facing away from the at least one conveying means, a facility (such as an air cushion table) for (normally temporary) storage or guidance of commodities at one side of a portion of the predetermined path, and means for evacuating selected commodities of the series from the at least one conveying means. The evacuating means comprises a transfer unit located at the aforementioned (normally upper) sides of commodities in the aforementioned portion of the path, means for moving the transfer unit transversely of the portion of the path, and means for transferring selected commodities from the portion of the path to the facility in response to movement of the transfer unit transversely of the portion of the path. The purpose of the just outlined construction, location and configuration of the evacuating means and of the aforementioned facility is to ensure, among others, that the transfer of one or more commodities from the selected portion of the predetermined path will necessitate only a very short-lasting interruption of advancement of commodities along the predetermined path toward and in the selected portion of such path. All this will be explained in considerable detail hereinafter.

The commodities can constitute stacks (such as reams) of superimposed flat sheets and/or other sheets of paper (such as bond paper or copy paper). The stacks are or can be guided in their path in such a way that their lateral faces extend in at least substantial parallelism with the predetermined direction, and the means for transferring the thus oriented stacks can include at least one transfer member which is arranged to engage at least one lateral face of each stack which is located in the selected portion of the path and is to be transferred into or onto the facility. If the aforementioned sides of the commodities in the predetermined path are the upper sides of such commodities, the transfer unit is located above the upper sides of commodities in the selected portion of their path. The transfer unit can include at least one pusher which is spaced apart from the upper sides of commodities in their path, and the means for transferring can include at least one transfer member which is carried by and is movable relative to the pusher.

It is often preferred to employ transferring means having two transfer members which are pivotable relative to the pusher and each of which can engage a different one of two parallel lateral faces of a commodity in the selected portion of the path. The transfer members can include flaps which are pivotable relative to the pusher about axes extending in at least substantial parallelism with the direction of movement of the series of commodities along their path. The arrangement can be such that the flaps are pivotable between first positions in which they abut the respective lateral faces of a commodity in the selected portion of the path and second positions in which they are spaced apart from the commodities in the selected portion of the path as well as from the commodity or commodities in or on the facility. The flaps can be mounted for pivotal movement through at least substantially 90 degrees relative to the pusher.

Each pusher can be mounted for movement from a first position in which it engages at least one commodity in the selected portion of the path preparatory to movement of the transfer unit transversely of the selected portion of the path in a direction to transfer the at least one commodity to the facility, and a second position in which the pusher is located at a level above the transferred commodity or commodities in or on the facility and above each commodity in the selected portion of the path for unimpeded return movement to the first position, i.e., without interference by commodities in or on the facility and in the selected portion of the path.

The evacuating means preferably further comprises means for guiding the transfer unit for movement transversely of the selected portion of the path. Such portion of the path is or can be straight and the means for guiding can extend at right angles to the straight portion of the path.

The at least one conveying means can comprise a table having an upper side provided with at least one recess, and at least one endless conveying element in the at least one recess. The at least one conveying element is or can be slidable along the table in the at least one recess. Such conveying means can further comprise means (e.g., one or more fluid-operated elevators) for raising and lowering the at least one conveying element in the at least one recess to and below the upper side of the table. The apparatus can further comprise means (e.g., an electronic control unit with sensor means, prime mover means, information storing means and other standard components) for synchronizing the movements of the transfer unit transversely of the selected portion of the path with raising and lowering of the at least one conveying element in the at least one recess.

In accordance with a highly advantageous feature of the invention, the apparatus can further comprise second conveying means defining a second path having a selected portion adjacent the facility; the latter is disposed between the selected portions of the two paths, and the evacuating means is preferably arranged to transfer commodities between the selected portions of the two paths across the facility with or without a pause at the instant or instants when the commodity or commodities which are being transferred are located in or on the facility. The selected portions of the two paths are or can be at least substantially parallel to each other. The transferring means of such evacuating means can comprise the aforementioned plural transfer members (such as flaps) which are operative to move commodities between the selected portions of the two paths and the facility, e.g., from either of the selected path portions into or onto the facility, from the facility into at least one of the selected path portions, or from one path portion into the other path portion (across the facility).

The facility can comprise a table having an upper side for reception of commodities from at least one of the conveying means, and the conveying means can comprise additional tables which are adjacent the table of the facility. At least one of the additional tables can be integrated into the table of the facility. The tables have upper sides which are arranged to support commodities being transferred by the transferring means, and such upper sides are or can be located in a common plane. The arrangement can be such that the plural tables constitute sections or portions of a single table, and at least a portion of such single table can constitute an air cushion table. An apparatus of the just outlined character can employ one, two or more air cushion tables, for example, discrete air cushion tables forming part of the two conveying means and at least one additional air cushion table forming part of or constituting the facility.

The improved apparatus can employ one or more air cushion tables even if it comprises a single conveying means; for example, such apparatus can comprise at least one first air cushion table defining the selected portion of the path for advancement of commodities by the single conveying means, and one or more additional air cushion tables forming part of or constituting the facility.

The transferring means is or can be designed to simultaneously transfer a plurality of commodities, e.g., a file of two or more stacks which may but need not abut each other.

If the facility comprises at least one air cushion table for temporary support or for temporary support and guidance of commodities, such table can include a panel having an upper side provided with a plurality of openings (e.g., openings in the form of ports each of which can be bounded by a cylindrical surface or a corrugated tubular surface), a blower, an accumulator or another suitable source of compressed air which is connectable to the ports (e.g., by one or more flow and/or pressure regulating valves) to establish an air cushion between the upper side of the panel and a commodity above the panel, and valving elements provided in and movable relative to the respective ports under the weight of commodities on the panel from raised positions partially projecting beyond the upper side of the panel to depressed positions to thus permit compressed air to flow from the ports and to establish the air cushion. The valving elements (which can constitute spheres made of or containing a suitable plastic material) cooperate with the adjacent portions of the panel to form open-and-shut valves which are opened by commodities to automatically initiate the establishment of one or more air cushions in response to advancement of one or more commodities onto or along the upper side of the panel.

An air cushion table of the just outlined character can be utilized with equal or similar advantage in each of the conveying means to define the selected portion of the respective path. Thus, each commodity which is advanced onto and advances along or rests in the selected portion of the path defined by the conveying means employing the just described table can initiate the establishment of an air cushion which reduces or eliminates friction between the commodity or commodities and the panel of the air cushion table regardless of whether the commodity or commodities is or are to advance along the path beyond the selected portion or from the selected portion onto or into the adjacent facility.

The just described air cushion table of the single conveying means or of one of plural conveying means can be installed adjacent a similar or identical air cushion table which constitutes or forms part of the facility that serves for temporary storage or for transit of one or more commodities onto a second conveying means or back into the selected portion of the path defined by conveying means from which the evacuating means has transferred one or more commodities into or onto the facility.

The improved air cushion table is believed to constitute an innovation which is patentable per se as well as in combination with other devices, arrangements or units, such as a constituent of the above outlined apparatus regardless of whether in a single conveying means, in one or each of several conveying means or as a facility adjacent a single conveying means or between neighboring conveying means.

Moreover, the improved air cushion table can serve to receive commodities from and/or to deliver commodities to conveying means other than those described hereinbefore. For example, the table can receive commodities from above and can support such commodities preparatory to transport onto at least one neighboring conveying means.

A further feature of the invention resides in the provision of a method of manipulating substantially block-shaped commodities. One embodiment of such method comprises the steps of advancing a series of successive commodities in a predetermined direction along a predetermined path, interrupting the advancement of commodities in and upstream of a predetermined (selected) portion of such path, and evacuating at least one commodity of the series from the selected portion of the path. The evacuating step includes moving the at least one commodity in a direction and by at least one implement (e.g., the aforementioned flap or flaps) such that the advancement of commodities in the predetermined direction toward and beyond the selected portion of the path can be resumed immediately upon completion of evacuation of the at least one commodity from the selected portion of the path.

The moving step can include lowering the at least one implement from a starting position into engagement with the at least one commodity in the selected portion of the path, and such method can further comprise the step or steps of raising the at least one implement to a level above the commodities in the selected portion of the path and returning the thus raised implement to the starting position.

The evacuating step can be carried out immediately upon start and in the course of the interrupting step.

The aforementioned moving step can include transferring the at least one commodity into a second path which is at least substantially parallel to the predetermined path.

The method can also include the step of applying a force from above to the at least one commodity in the selected portion of the aforementioned predetermined path. Such force applying step can involve the deposition of one or more weights onto the commodity or commodities about to be transferred or evacuated from the selected portion of the predetermined path. The weight or weights can form part of the at least one implement so that it or they can be lowered, raised and otherwise moved with the at least one implement. Other means for applying a force to the upper side(s) of the commodity or commodities about to be evacuated from the selected portion of the predetermined path can be utilized with equal or similar advantage. For example, it is possible to employ at least one nozzle which directs one or more jets of a gaseous fluid against the top surface of each commodity which is about to be transferred from the selected portion of the predetermined path onto or into a facility or into a selected portion of a path defined by a second conveyor.

An important advantage of the force applying step is that it reduces the likelihood of shifting of one or more sheets at the top of a commodity in the form of a stack of superimposed sheets when the stack is abruptly moved sideways from the selected portion of the predetermined path onto or into a facility or onto a conveyor.

As a rule, it suffices to apply the force only in the course of the evacuating or transferring step, i.e., while the at least one implement engages one or more commodities in the selected portion of the predetermined path and is in motion to move such commodity or commodities out of the path onto an air table or to another destination.

Another embodiment of the improved method comprises the steps of advancing a file of successive commodities in a predetermined direction along a first path, interrupting the advancement of commodities in and upstream of (i.e., behind) a predetermined portion of the first path (such portion is long enough to accommodate at least two successive commodities), transferring the at least two successive commodities from the predetermined portion of the first path into a second path subsequent to initiation of the interrupting step, and conveying the at least two successive commodities along the second path.

The just outlined method can comprise the additional step of resuming the advancement of commodities in the predetermined direction along the first path into and beyond the predetermined portion of the first path immediately upon completion of the transferring step.

Successive commodities of the file can be immediately adjacent each other; for example, they can abut one another.

The conveying step can include conveying the at least two successive commodities along the second path in the predetermined direction (i.e., in the direction in which the commodities are transported or advanced along the first path). Alternatively, the conveying step can include conveying the at least two successive commodities along the second path in a further (different) direction, especially at least substantially counter to the predetermined direction.

In accordance with a presently preferred embodiment, the commodities which are manipulated in accordance with the method or methods of the present invention are stacks of superimposed sheets of paper, cardboard, plastic material and/or metallic foil.

The novel features which are considered as characteristic of the invention are set forth in particular in the appended claims. The improved apparatus itself, however, both as to its construction and the modes or methods of assembling and/or operating the same, together with numerous additional important features, attributes and advantages thereof, will be best understood upon perusal of the following detailed description of certain presently preferred specific embodiments with reference to the accompanying drawings.

### BRIEF DESCRIPTION OF THE DRAWINGS

FIG. 1 is a schematic partly elevational and partly transverse vertical sectional view of an apparatus which embodies one form of the invention and employs two parallel conveyors and a commodity-supporting facility in the form of an air cushion table between selected portions of the conveyors;

FIG. 2 is an enlarged view of a detail of the structure shown in FIG. 1, namely of one of the conveyors; and

FIG. 3 is a schematic smaller-scale plan view of the apparatus and of the machine which delivers commodities in the form of stacks of paper sheets or the like to one of the conveyors ahead of the air cushion table.

### DESCRIPTION OF PREFERRED EMBODIMENTS

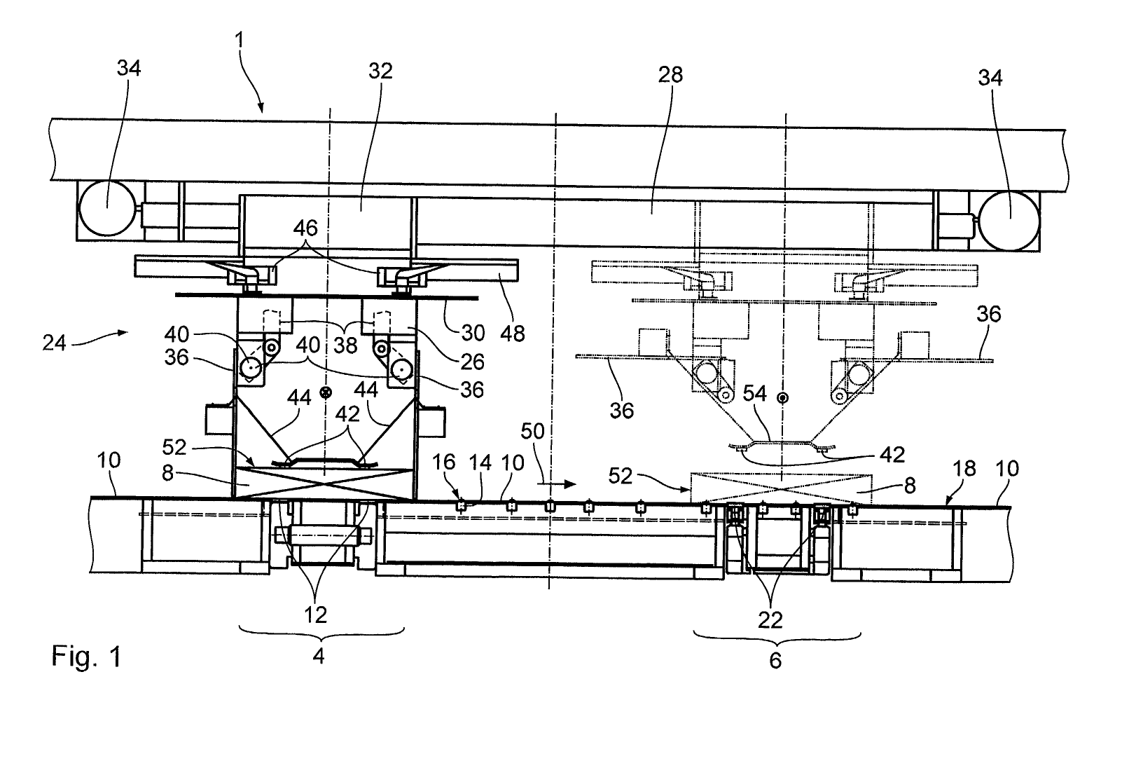

Referring to FIG. 1, there is shown an apparatus for transferring, when necessary or in accordance with a schedule, individual commodities 8 or groups 2 of several successive commodities 8, from an elongated path which is defined by a first endless belt conveyor 4 into an elongated path defined by a second endless belt conveyor 6 or onto or into a facility 10A (shown in the form of an air cushion table) between selected portions of the paths defined by the two conveyors. The selected portions of the two paths are defined by two additional air cushion tables 10 which flank the table 10A and form part of the respective conveyors 4, 6.

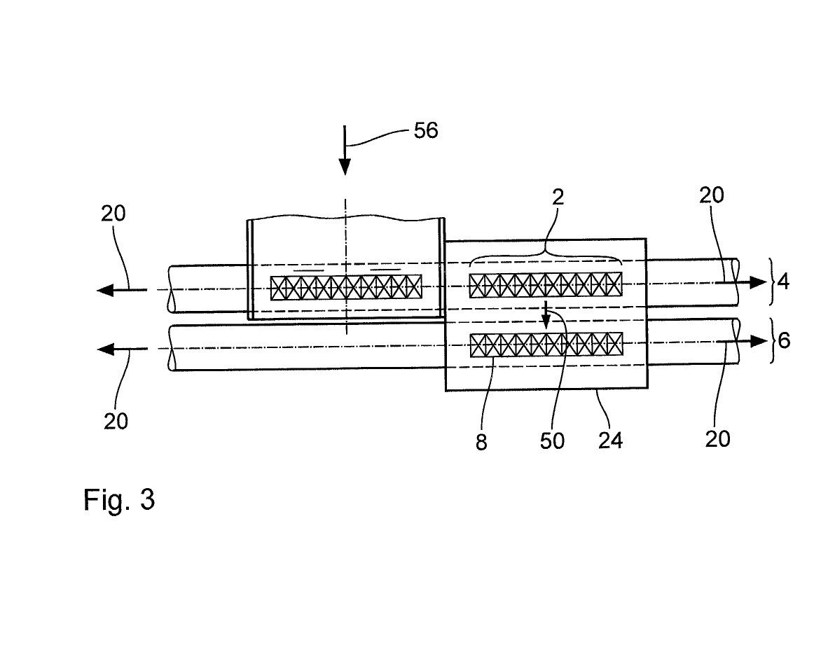

As shown in FIG. 3, each group 2 consists of a series of ten successive individual commodities 8 constituting stacks of superimposed sheets of paper, cardboard, plastic and/or metallic material. The stacks 8 of each group 2 actually contact each other; however, the improved apparatus can function just as satisfactorily when used to transfer groups of two or more successive spaced-apart stacks or individual stacks.

The arrow 56 denotes in FIG. 3 the direction of advancement of stacks 8 from a suitable source, e.g., the aforediscussed sheeter which is designed to subdivide panels or running webs of paper or the like into individual sheets and to gather predetermined numbers of sheets into stacks 8 which are delivered to the conveyor 4 in the direction indicated by the arrow 56. The sheeter comprises one or more severing devices (not shown), depending on the dimensions of the starting material. The severing devices (in the form of longitudinal or cross cutters) sever the starting material lengthwise and/or crosswise, and the thus obtained files of individual sheets are thereafter caused to partially and thereupon fully overlap to form a succession of discrete stacks 8, e.g., reams each of which contains 500 superimposed sheets.

The arrow 20′ indicates in FIG. 3 the direction of normal transport of stacks 8 or successive groups 2 of stacks 8 to a processing machine or unit (not shown), such as a wrapping machine. However, and as shown in FIG. 3 by the arrow 20, the conveyor 4 can be designed to transport stacks 8 in a direction to the right (as indicated by the arrow 20′) or to the left, e.g., to another consumer or to storage, not shown. The same holds true for the second conveyor 6, i.e., this conveyor can transport individual stacks 8 or groups 2 of stacks to the right (as indicated by the arrow 20′), e.g., to a wrapping machine, or to the left (note the arrow 20) to storage or to another consuming or processing machine (not shown in FIG. 3).

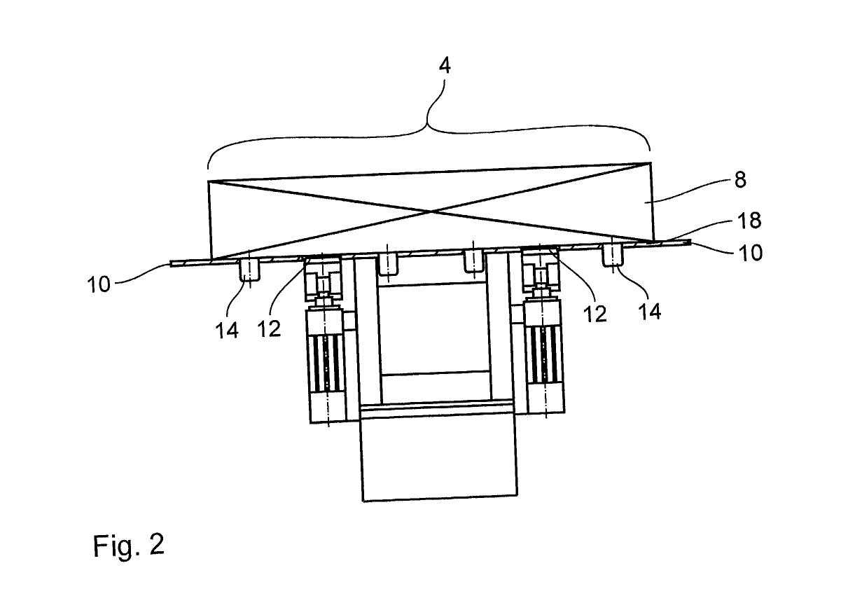

As can be best seen in FIG. 2, the conveyor 4 comprises two spaced-apart parallel endless belts or bands 12 received in recesses 18a provided in the upper side 18 of a panel 10p forming part of one of the two air cushion tables 10, i.e., of the table which forms part of the conveyor 4. The table 10 of FIG. 2 defines an internal plenum chamber 18b which can receive compressed air or another gaseus fluid from a source 15 by way of one or more conduits 15b (one shown) containing adjustable pressure and/or flow regulating valves 15a. The chamber 18b communicates with individual ports 18c which are provided in the upper side 18 of the panel 10p of the table 10 and receive preferably spherical valving elements 16 preferably containing or made of a plastic material, especially a lightweight plastic material.

The pressure of compressed gas in the plenum chamber 18b of the table 10 shown in FIG. 2 is selected in such a way that the valving elements 16 are urged upwardly to their upper end positions (shown in the table 10A of the aforementioned stack supporting and guiding facility) in which the top portions of the valves 6 extend upwardly beyond the upper side 18 of the panel 10p. However, the valving elements 16 yield and descend in their ports 18c when depressed by a stack 8 (as shown in FIG. 2) whereby the upper ends of the ports 18c are free to discharge compressed air streams which establish an air cushion between the upper side 18 of the panel 10p and the underside of the stack 8 above such panel. The air cushion causes the stack 8 to float atop the panel 10p, i.e., such air cushion greatly reduces or eliminates friction between the table 10A and the stack 8 thereon; this is desirable because one ensures that the stack 8 can be moved along the table 10A toward and onto the conveyor 6 or back onto the conveyor 4 in response to the exertion of a relatively small force. It is clear that the surfaces bounding the ports 18c are configurated in such a way that the spherical valving elements 16 can partially project beyond the upper side 18 of the panel 10p but cannot be fully expelled from their respective ports.

The facility with which a stack 8 above the upper side 18 can be moved along the panel 10p is further enhanced due to the fact that the spherical valving elements 16 can roll in their ports 18c in response to a shifting of the stack relative to the air cushion table. Furthermore, the pressure of fluid in the plenum chamber 18b can be reduced to a surprising extent by utilizing spherical valving elements 16 and even more if the valving elements are made of a plastic material, especially a suitable lightweight plastic material.

The construction of the air cushion table 10 forming part of the conveyor 6 is or can be identical with that of the air table 10 shown in FIG. 2 and forming part of the conveyor 4. In each of FIGS. 1 and 2, the stacks 8 are adapted to be advanced toward or away from the observer of these Figures in order to be moved in the direction indicated by an arrow 20 or 20′ of FIG. 3. On the other hand, a stack 8 which is to be moved from the air cushion table 10 of the conveyor 4 of FIG. 1 onto the air cushion table 10A of the facility between the conveyors 4, 6 or all the way onto the air cushion table 10 of the conveyor 6 must be advanced (pushed when manipulated by the apparatus of FIGS. 1 to 3) in the direction indicated by the arrow 50 shown in each of FIGS. 1 and 3. The manner in which the motors which are utilized to drive the conveyors 4 and 6 can be reversed (e.g., by resorting to suitable electric switches if the motors are electric motors) in order to drive the respective belts 12 in the direction of arrow 20 or 20′ is well known and is not shown in the drawings.

FIG. 1 shows that the belts 12 of the conveyor 4 are maintained in the respective recesses 18a. Thus, the stack 8 shown in the left-hand portion of FIG. 1 (this stack can constitute a discrete stack or one of a series or file 2 of ten successive stacks) is supported by the air cushion then defined by the respective table 10. The means for raising and lowering the upper reaches of the belts 12 above and into the respective recesses 18a comprises suitable elevators 12a shown in FIG. 2, e.g., hydraulically or pneumatically operated cylinder and piston units.

The means (24) for evacuating selected stacks 8 or groups 2 of stacks 8 of the series of stacks 8 in the path defined by the conveyor 4 comprises a transfer unit including a pusher 26 located at a level above the upper side(s) of the stack(s) on the table 10 of the conveyor 4, i.e., at that side of each stack on the table 10 of the conveyor 4 which faces away from this: conveyor. The pusher 26 carries a two-piece stack transferring means including two pivotable flaps 36.

Apparatus of the type shown in FIG. 1 are known as transposers (denoted by the character 1) and the evacuating means 24 constitutes the main constituent of the illustrated transposer. The pusher 26 is mounted on an overhead carriage 32 which is slidable along an elongated horizontal guide (e.g., a rail) 28 extending across the space above the tables 10 of the conveyors 4, 6 as well as across the space above the table 10A of the facility between the tables 10. A horizontal plate 30 of the pusher 26 is mounted on the reciprocable carriage 32 by adjusting members 46 which can be manipulated to change the distance between the parallel horizontal pivot members 40 for the two flaps 36. The means for moving the carriage 32 alog the guide 28 comprises one or more prime movers 34, e.g., a first prime mover which serves to move the carriage 32 in a direction to the right and a second prime mover which serves to move the carriage in a direction to the left (as viewed in FIG. 1).

Each of the flaps 36 is pivotable between a vertical position (shown in the left-hand portion of FIG. 1 above the table 10 of the conveyor 4) in which it extends downwardly from the respective pivot member and its lower portion is adjacent one side face of the stack 8 shown on the table 10 of the conveyor 4, and a normally horizontal or substantially horizontal position 36′ (shown in the right-hand portion of FIG. 1) in which it is located at least slightly above the level of the upper side(s) 52 of stack(s) on the table 10A, on the table 10 of the conveyor 4 and/or on the table of the conveyor 6. The means 38 for pivoting the flaps 36 between the two positions (e.g., through angles of 90 degrees) is mounted on the pusher 26 and can comprise two link trains receiving motion from a common reversible prime mover or from two discrete prime movers.

An optional (but often highly desirable) feature of the evacuating means 24 includes the provision of a wide and/or elongated (e.g., square or rectangular) mass or weight 42 which is suspended from cables 44 carried by the flaps 36 to come to rest in automatic response to pivoting of the flaps 36 to their operative (vertical) positions at opposite lateral side(s) or face(s) of the stack or stacks 8 on the table of the conveyor 4. The weight 42 can come to rest on the upper side(s) 52 of the stack(s) 8 on the table 10 of the conveyor 4 to exert a force acting in a direction toward the upper side 18 of the panel 18b of such table. Thus, the stack 8 which is shown in FIG. 1 on the table 10 of the conveyor 4 is acted upon from above by the force of the weight 42 and from below by the cushion of compressed air issuing from the ports 18c. Such “clamping” of the illustrated stack 8 between the weight 42 and the air cushion above the panel 10p prevents, or at least greatly reduces the likelihood of, any shifting of the uppermost and/or lowermost sheets of the stack 8 relative to the median sheets during transport of the stacks from the table 10 of the conveyor 4 onto the table 10A or all the way onto the table 10 of the conveyor 6.

The likelihood of deformation and/or defacing of the topmost sheet or sheets of a stack 8 on the table 10 of the conveyor 4 and/or during transfer onto the table 10A or onto the table 10 of the conveyor 6 is very remote due the preferably large size of the weight 42 as well as because the stack 8 is “clamped” between such weight and a yieldable air cushion above the upper side 18 of the panel 18p forming part of the table 10 in the conveyor 4. The belts 12 of the conveyor 4 are or can be retracted into the respective recesses 18a to reduce the likelihood or the extent of friction between the underside of a stack 8, which is being pushed by the left-hand pusher 36, and the table 10.

The purpose of the means 46 for adjusting the spacing between the two pivots 40 for the flaps 36 is to enhance the versatility of the evacuating means 24. Thus, the pivots 40 for the flaps 36 can be moved toward or away from each other to ensure that the flaps can properly engage the lateral faces of the stack 8 on the table of the conveyor 4 preparatory to shifting the stack onto the table 10A or onto the table 10 of the conveyor 6. For example, the adjustment of the distance between the pivots 40 (as seen in the direction of the arrow 50) can be such that the lower portions of the flaps 36 lie flush against the lateral faces of the stack 8 between them when the flaps are caused to assume their upright positions.

Furthermore, the adjusting means 46 renders it possible to utilize the novel evacuating means 24 for the transfer of wider or narrower stacks 8 (as seen in the direction of the arrow 5 ) with equal facility and with the same degree of accuracy. A stack 8 which is properly confined between the two accurately adjusted flaps 36, the weight or weights 42 and the air cushion above the panel 10p of the table 10 forming part of the conveyor 4 is highly unlikely to alter its shape during transfer off the conveyor 4.

The two halves of the adjusting means 46 (for the respective halves of the pusher 26 and the corresponding pivots 40 and flaps 36) are movable along a horizontal guide 48 mounted on the carriage 32 at a level beneath the guide 28 for the carriage.

The operation of the evacuating means 24 will be readily understood upon perusal of the preceding part of this specification. Thus, once the flaps 36 have assumed their operative positions of engagement with the lateral face(s) of the stack(s) 8 on the table 10 of the conveyor 4 (this causes the weight or weights 42 to come to rest on the upper side(s) 52 of such stack or stacks), the belts 12 are lowered by the elevators 12a and the motor means 34 can be started to move the carriage 32 in the direction of the arrow 50. The illustrated stack 8 on the conveyor 4 of FIG. 4 then slides along the air cushion above the respective panel 10p and its sheets remain in the desired positions of accurate overlap with each other due to the forces exerted by the weight 42 and the air cushion above the table 10 of the conveyor 4.

The conveyor 4 is arrested during that stage of transfer of one or more stacks 8 from its table 10 which involves the pushing of the stack or stacks off such table by the left-hand pusher 36 of FIG. 1. It is not even necessary to maintain the conveyor 4 at a standstill during the entire stage of transfer of one or more stacks off the left-hand table 10 of FIG. 1. All that counts is to ensure that the path portion above the left-hand table 10 of FIG. 1 is cleared sufficiently to permit the file 2′ of stacks 8′ located to the left of the table 10 of the conveyor 4 shown in FIG. 3 to enter the space above such table 10. Otherwise stated, the conveyor 4 can be restarted as soon as the left-hand flap 36 of FIG. 1 is moved sideways at least to but preferably at least slightly beyond the vertical position of the right-hand flap 36 above the conveyor 4 of FIG. 1.

Restarting of the conveyor 4 involves a lifting of the upper reaches of the belts 12 to a level above the upper side 18 of the panel 10p forming part of the respective table 10; this enables the upper reaches of these belts to advance the file 2′ of FIG. 3 onto and beyond such table.

The return movement of the pusher 26 to the starting (left-hand) position of FIG. 1 can begin as soon as the flaps 36 are lifted above the common level of the upper sides 52 of the stacks 8 shown in FIG. 1, i.e., even before the flaps 36 reach the raised positions 36′ shown in the right-hand portion of FIG. 1. The weight or weights 42 is or are lifted to a level above the upper side(s) of the freshly transferred stack(s) 8 together with the pivoting of the flaps 36 about the horizontal axes of the respective pivots 40 to the raised positions 36′. FIG. 1 shows that the illustrated weight is a composite weight including at least two discrete weights 42 which are joined to each other by a link 54 serving to prevent movements of the two discrete weights relative to each other. It is clear that the aforementioned force can be applied to the upper side(s) of the stack(s) 8 above the table 10 of the conveyor 4 by resorting to a single (one-piece) weight or to a combination of three or more weights. Furthermore, the means for coupling the weight or weights 42 to the pusher 26 can comprise one or more linkages or the like in lieu of or in addition to the cables 44.

The second conveyor 6 is or can be brought to a halt jointly with the first conveyor 4. If the apparatus is to operate in a manner as shown in FIG. 1, i.e., to transfer one or more stacks 8 from the table 10 of the conveyor 4 across the table 10A and onto the table 10 of the conveyor 6, the upper reaches of the belts 12 of the conveyor 6 can be lifted above the upper side of the panel of the respective table 10 and the transport of the file 2″ of stacks 8″ (in the direction of the arrow 20′) can proceed as soon as the weight or weights 42 are lifted off the upper sides 52 of the stacks below them. In fact, it is advisable to at least temporarily start the conveyor 6 prior to completed transfer of one or more stacks 8 off the table of the conveyor 4 or prior to transfer of such stack or stacks sideways beyond the table 10A: this might be necessary in order to provide room for transfer of one or more stacks from the table 10 of the conveyor 4, across the table 10A and onto the table 10 of the conveyor 6.

The fact that the pusher 26 of the evacuating means 24 is located at a level above the table 10 of the conveyor 6 does not affect the ability of this conveyor to advance stacks 8 or 8′ or 8″ in the direction of the arrow 20 or 20′, as long as the flaps 36 are pivoted all the way to the raised positions 36′ or sufficiently above the level of the upper sides 52 of stacks on a table 10 or on the table 10A to ensure that the flaps cannot interfere with movements of stacks with the conveyor belts 12 of the conveyor 6.

In order to proceed with the transfer of one or more stacks 2 or 2′ off the table 10 of the conveyor 4 onto the table 10A or onto the table 10 of the conveyor 6, the carriage 32 is returned to the starting (left-hand) position of FIG. 1 by the motor means 34 while the flaps 36 are held in the positions 36′ or only slightly above the level of the upper sides 52 of the stacks. The afore-described procedure is thereupon repeated, i.e., the flaps are pivoted from the positions 36′ to the vertical positions 36, the weight or weights 42 are simultaneously lowered onto the upper side(s) of the stack(s) on the table 10 of the conveyor 4, and the motor means 34 is started to advance the carriage 32 along the guide 28 from the level above the conveyor 4 to the level above the table 10A or to the level above the table 10 of the conveyor 6. The conveyor 4 as well as the conveyor 6 can be operated in normal fashion, i.e., to advance stacks or files of stacks in the direction of the arrow 20 or 20′, while the carriage 32 is in the process of returning the pusher 26 to the position shown in the left-hand part of FIG. 1.

As already mentioned hereinbefore, the table 10 of the conveyor 6 can be identical with or clearly analogous to the table 10 of the conveyor 4. Furthermore, the table 10 of the conveyor 4 or 6 can be identical with the table 10A of the facility between the tables 10. However, the top panel of the table 10A need not be provided with recesses 18a for belts 12 or the like because, in the illustrated apparatus, the table 10A merely serves as a temporary storage facility for one or more stacks and/or as a means for supporting from below that stack or those stacks which are being transferred from the table 10 of the conveyor 4 onto the table 10 of the conveyor 6 or vice versa.

The tables 10 can be of one piece with the table 10A, e.g., to the extent that all three tables share a common panel 10. Alternatively, the table 10A can be of one piece with the table 10 of the conveyor 4 or 6, or each of the three tables can constitute a discrete air cushion table.

The method which can be practiced by resorting to the apparatus (transposer 1) of FIGS. 1 to 3 can comprise at least three steps (the number of steps depends, at least to a certain extent, upon the extent of transfer of stacks from the table 10 of the conveyor 4 or 6), namely advancing commodities (such as 8′, 8, etc.) in a predetermined direction (20′) along a predetermined path (defined by the conveyor 4), interrupting the advancement of commodities by the conveyor 4 in and upstream of a predetermined portion (see the table 10 of the conveyor 4) of the path, and evacuating (by the evacuating means 24) at least one commodity (8 of the series 2 in FIG. 3) from the predetermined portion (on 10 of 4) in the predetermined path. The evacuating step includes moving the at least one commodity in a direction (50) and by at least one implement 36 such that the advancement of commodities in the predetermined direction (20′) and beyond the predetermined portion (on the table 10 of the conveyor 4 of FIG. 3) of the path can be resumed immediately upon completion of evacuation of the at least one commodity from the portion of the path, i.e., from the table 10 of the conveyor 4.

Thus, the minimal number of steps is surprisingly small which is desirable and advantageous on the ground that the normal transport of stacks by the conveyor 4 and/or 6 can be resumed after a very short interruption of operation of such conveyor or conveyors. This is attributable to a considerable extent to the novel concept of lifing the flap or flaps 36 at least slightly above the level of the upper sides 52 of the stacks as soon as the transfer of one or more stacks off the table 10 of the conveyor 4 is completed, so that the pusher 26 of the evacuating means can reassume its starting position.

The flaps 36 can be relatively thin; this also contributes to a shortening of intervals of idleness of the conveyor 4 and/or 6 for the purpose of transferring one or more stacks off the conveyor 4 onto the table 10A or onto the conveyor 6, of transferring one or more stacks off the conveyor 6 onto the table 10A or onto the conveyor 4, or of transferring one or more stacks off the table 10A onto the conveyor 4 or 6.

A further important advantage of the improved method and apparatus is that the evacuating means 24 occupies space which is normally available in a transposer, namely, at a level above the upper sides 52 of the stacks 2. With reference to FIG. 1, and assuming that the evacuating means 24 is set up to transfer stacks 8 from the conveyor 4 onto the conveyor 6, the only instance when a portion (namely the lower parts of the flaps 36) of the evacuating means must descend to a level below the upper sides 52 of the stacks 8 is immediately prior to and during shifting of one or more stacks off the table 10 of the conveyor 4, across the table 10A of the facility between the conveyors 4, 6 and onto the table 10 of the conveyor 6. The pushers, tongs or similar implements of conventional apparatus remain at a fixed level so that, if such implements were to be utilized in the apparatus of FIG. 1, the conveyor 4 could be restarted only upon completion of return movement of the implements all the way to their starting positions. The resulting combined durations of interruptions of operation of the conveyor 4 would entail significant reduction of the output of the conveyor 6 and of the entire transposer.

The evacuating means 24 could operate with a single flap 36 (namely with the left-hand flap of FIG. 1) if the apparatus were set up to transfer stacks only from the conveyor 4 onto the table 10A or onto the conveyor 10. However, the utilization of two flaps 36 or analogous implements is preferred because the right-hand flap 36 of FIG. 1 cooperates with the left-hand flap to prevent a shifting of certain sheets of a stack which is being pushed off the conveyor, namely a shifting in the direction indicated by the arrow 50. Furthermore, the provision of two flaps 36 renders it possible to transfer stacks in the direction of the arrow 50 as well as (or) counter to such direction. The two flaps 36 can be said to constitute the lateral panels of a rudimentary inverted box which is open at the bottom and the top of which is constitued by or includes the weight or weights 42 and the link 54.

It is possible to employ an evacuating means with two flaps 36 and with two flaps extending transversely of the direction indicated by the arrow 20 or 20′. Such evacuating means with a truly box-shaped stack transferring device can be utilized if the stacks of a series of stacks on the conveyor 4 or 6 are spaced apart from each other in the direction indicated by the arrows 20 or 20′. The additional stacks can be mounted for pivotal movement about horizontal axes which are normal to the direction of advancement of stacks on the conveyor 4 or 6. The evacuating means 24 with only two flaps 36 is preferred at this time because such flaps can engage and transfer a single stack or two or more successive stacks regardless of whether or not the stacks on the conveyor 4 or 6 abut each other. It is merely necessary that the length of the flaps 36 in the direction of the arrow 20 or 20′ does not exceed the corresponding dimension of a stack 8 if the flaps 36 are to transfer discrete stacks taken from a series of abutting stacks.

It is also possible to provide the evacuating means 24 with flaps 36 which are adjustable axially of the respective pivots 40. Still further, it is possible to furnish the evacuating means 24 with several pairs of (shorter and longer) flaps which can be readily attached to and detached from the respective pivots 40.

Still further, it is possible to employ evacuating means which is movable up and down in its entirety; in such evacuating means, the flaps 36 need not be pivotably secured to horizontal pivots because their mutual positions can remain unchanged. The illustrated evacuating means 24 is preferred at this time because the overall weight (and hence the inertia) of parts which must be raised and lowered is reduced considerably.

The pivoting of flaps 36 to and from the horizontal positions 36′ constitutes an optional but highly desirable and advantageous feature. Thus, when the flaps 36 are held in the horizontal positions 36′ shown in the right-hand portion of FIG. 1, they offer a minimum of resistance to movement back to the starting positions in which the flaps are ready to be pivoted into parallel vertical planes as shown in the left-hand portion of FIG. 1. Furthermore, when caused to assume the positions 36′, the flaps 36 are highly unlikely to generate currents (such as eddies) of air which would be likely to shift the topmost sheet or sheets of the stack(s) on the table 10A and/or on the table 10 of the conveyor 4 during return movement of the evacuating means 24 to the starting position of FIG. 1.

In accordance with a modification (not shown), the flaps 36 can be provided with numerous and/or large holes or windows for the flow of air therethrough. This reduces or eliminates the likelihood of undesirable agitation of surrounding air during return movement of the flaps from the positions above the conveyor 6 to the positions above the conveyor 4 even if such return movement takes place while the flaps are inclined to the horizontal and while the flaps are advanced at a high or very high speed.

The combined width of the belts 12 in the recesses 18a of a table 10 can constitute a relatively small fraction of the width of a stack 8. This does not affect the reliability of advancement of successive stacks above the table 10 of the conveyor 4 or 6 because the elevators 12a can be actuated to lower the upper reaches of the belts 12 into the respective panels 10p so that the lowermost sheets of the stacks can slide along the upper sides 18 of the panels 10p or on the aforediscussed air cushions.

The movements of the belts 12 in response to actuation of the respective elevators 12a can be synchronized with operation of the motor means 34, i.e., with movements of the flaps 36 to and from the starting or operative positions shown in the left-hand portion of FIG. 1. The synchronizing means 5 is shown schematically in the upper left-hand portion of FIG. 1.

The improved transposer can be modified by omitting the conveyor 4 or 6. Two conveyors can be employed with advantage if the output of a single sheeter is to be divided and each half (or another percentage) delivered to a discrete processing machine (e.g., a wrapping or packing machine for reams of paper sheets). If one of the conveyors 4, 6 is omitted, the table 10A merely serves as a means for temporary storage of one or more stacks prior to their return onto the single conveyor. Furthermore, such table 10A can serve to receive and temporarily support defective stacks which should not reach the processing machine. Such defective stacks can be detected anywhere between the sheeter and the table 10 of the single conveyor 4 or 6.

The utilization of two parallel conveyors is preferred in many instances. As already explained hereinbefore, and if the apparatus operates with two conveyors, the conveyor 4 can be restarted as soon as the left-hand flap 36 of FIG. 1 has completed the transfer of one or more stacks off the table 10 of the conveyor 4 or even before, namely as soon as the left-hand flap 36 has been moved to the right (arrow 50 in FIG. 1) through a distance at least slightly exceeding the width of the transferred stack or the width of a file of transferred stacks.

The improved air cushion table or tables 10 and/or 10A can be utilized with advantage not only in a transposer but also for many other purposes, not only in connection with temporary storage and/or transport of accumulations of superimposed paper sheets or the like but also for the manipulation of numerous other types of commodities. The utilization of lightweight valving elements (16) renders the improved table or tables particularly suitable for use in the illustrated transducer because such valving elements can be moved to desired positions in response to the application of relatively low air pressure, i.e., a pressure which is not likely to entail damage to the lowermost sheets of stacks of paper sheets or the like, either by way of the spherical valving elements 16 and/or by jets of air issuing from the ports 18c in the upper side 18 of the respective panel 10p. Moreover, the feature that the valving elements 16 can be moved to desired positions by resorting to a pneumatic fluid the pressure of which need not be high, a table 10 or 10A is less likely to cause a shifting of the lowermost sheet or sheets of a stack which is supported by the air cushion and is contacted by the topmost portions of the depressed valving elements.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above outlined contribution to the art of manipulating stacks of sheets and the like and, therefore, such adaptations should and are intended to be comprehended within the meaning and range of equivalence of the appended claims.

What is claimed is:

1. Apparatus for manipulating substantially block-shaped commodities, comprising;
at least one means for conveying a series of commodities in a predetermined direction along a predetermined path wherein the commodities have sides facing away from said conveying means;
a facility for storage of commodities, said facility being adjacent one side of a portion of said path; and
means for evacuating selected commodities of said series from said conveying means, including a transfer unit located at said sides of commodities in said portion of said path, means for moving said transfer unit transversely of said portion of said path, and means for transferring selected commodities from said portion of said path to said facility in response to movement of said transfer unit transversely of said portion of said path.

2. The apparatus of claim 1, wherein the commodities include stacks of superimposed sheets.

3. The apparatus of claim 2, wherein the stacks in said path have lateral faces extending in at least substantial parallelism with said direction and said means for transferring includes at least one transfer member arranged to engage at least one face of at least one stack in said portion of said path.

4. The apparatus of claim 1, wherein said sides are the upper sides of commodities in said path and said transfer unit is located at a level above the upper sides of commodities in said portion of said path.

5. The apparatus of claim 4, wherein said transfer unit includes at least one pusher.

6. The apparatus of claim 5, wherein said pusher is spaced apart from the upper sides of commodities in said path and said means for transferring includes at least one transfer member carried by and movable relative to said pusher.

7. The apparatus of claim 6, wherein the commodities in said path have pairs of lateral faces and said means for transferring comprises two transfer members pivotable relative to said pusher, each of said transfer members being arranged to engage a different lateral face of a commodity in said portion of said path.

8. The apparatus of claim 7, wherein said transfer members include flaps.

9. The apparatus of claim 8, wherein said flaps are pivotable relative to said pusher about axes which are at least substantially parallel to said predetermined direction.

10. The apparatus of claim 9, wherein said flaps are pivotable between first positions in which they abut the respective lateral faces of a commodity in said portion of said path and second positions in which the flaps are spaced apart from the commodities in said portion of said path.

11. The apparatus of claim 10, wherein said flaps are pivotable through angles of at least substantially 90 degrees.

12. The apparatus of claim 6, wherein said at least one pusher is movable from a first position in which the pusher engages at least one commodity in said portion of said path preparatory to movement of said transfer unit transversely of said portion of said path in a direction to transfer the at least one commodity to said facility, and a second position in which said at least one pusher is located at a level above the transferred at least one commodity in said facility and above each commodity in said portion of said path for return movement to said first position without interference by commodities in said facility and said portion of said path.

13. The apparatus of claim 1, wherein said evacuating means further comprises means for guiding said transfer unit for movement transversely of said portion of said path.

14. The apparatus of claim 13, wherein said portion of said path is straight and said means for guiding extends at right angles to said straight portion.

15. The apparatus of claim 1, wherein said at least one conveying means comprises a table having an upper side provided with at least one recess, and at least one endless conveying element in said at least one recess.

16. The apparatus of claim 15, wherein said at least one conveying element is slidable along said table in said at least one recess.

17. The apparatus of claim 16, wherein said conveying means further comprises means for raising and lowering said at least one conveying element in said at least one recess to and below the upper side of said table.

18. The apparatus of claim 17, further comprising means for synchronizing the movements of said transfer unit transversely of said portion of said path with raising and lowering of said at least one conveying element in said at least one recess.

19. The apparatus of claim 1, further comprising second conveying means defining a second path having a portion adjacent said facility, said facility being disposed between said portions of said paths and said evacuating means being arranged to transfer commodities between said portions of said paths across said facility.

20. The apparatus of claim 19, wherein said portions of said paths are at least substantially parallel to each other.

21. The apparatus of claim 19, wherein said transferring means comprises transfer members operative to move commodities between said portions of said paths and said facility.

22. The apparatus of claim 19, wherein said facility comprises a table having an upper side for reception of commodities from at least one of said conveying means.

23. The apparatus of claim 22, wherein said conveying means comprise additional tables adjacent the table of said facility.

24. The apparatus of claim 23, wherein at least one of said additional tables is integrated into the table of said facility.

25. The apparatus of claim 23, wherein said tables have upper sides arranged to slidably support commodities being transferred by said transferring means.

26. The apparatus of claim 25, wherein the upper sides of said tables are located in a common plane.

27. The apparatus of claim 23, wherein said tables constitute portions of a single table.

28. The apparatus of claim 27, wherein at least a portion of said single table is an air cushion table.

29. The apparatus of claim 23, wherein at least one of said tables is an air cushion table.

30. The apparatus of claim 1, wherein at least one of said facility and said at least one conveying means comprises at least one air cushion table.

31. The apparatus of claim 1, wherein said transferring means comprises means for simultaneously transferring a plurality of commodities.

32. The apparatus of claim 1, wherein said facility comprises an air cushion table for temporary support of commodities, said table including a panel having an upper side provided with a plurality of ports, a source of compressed air connectable to said ports to establish an air cushion between said upper side and a commodity above said panel, and valving elements provided in and movable relative to the respective ports under the weight of commodities on said panel from raised positions partially projecting beyond said upper side to depressed positions to thus permit compressed air to flow from said ports and to establish the air cushion.

33. The apparatus of claim 32, wherein at least one of said valving elements includes a sphere.

34. The apparatus of claim 33, wherein said sphere contans a plastic material.

35. The apparatus of claim 1, wherein said portion of said path is defined at least in part by an air cushion table for temporary support of commodities, said table forming part of said at least one conveying means and including a panel including an upper side provided with a plurality of ports, a source of compressed air connectable to said ports to establish an air cushion between said upper side and a commodity above said panel, and valving elements provided in and movable relative to the respective ports under the weight of commodities on said panel from raised positions partially projecting beyond said upper side to depressed positions to thus permit compressed air to flow from said ports and to establish the air cushion.

36. The apparatus of claim 35, wherein at least one of said valving elements includes a sphere.

37. The apparatus of claim 36, wherein said sphere contains a plastic material.

38. The apparatus of claim 1, wherein said facility comprises a first table for temporary support of commodities and said portion of said path is defined by a second table for temporary support of commodities, at least one of said tables including a panel having an upper side provided with a plurality of ports, a source of compressed air connectable to said ports to establish an air cushion between said upper side and a commodity above said panel, and valving elements provided in said ports, said valving elements being movable relative to the respective ports under the weight of commodities on said panel from raised positions partially projecting beyond said upper side to depressed positions to thus permit compressed air to flow from said ports and to establish the air cushion.

39. An air cushion table for temporary support of commodities, comprising:
a panel having an upper side provided with a plurality of ports;
a source of compressed air connectable to said ports to establish an air cushion between said upper side and a commodity above said panel; and
valving elements provided in said ports, said valving elements being movable relative to the respective ports under the weight of commodities on said panel from raised positions partially projecting beyond said upper side to depressed positions to thus permit compressed air to flow from said ports and to establish said air cushion.

40. The table of claim 39, wherein at least one of said valving elements includes a sphere.

41. The table of claim 40, wherein said sphere contains a plastic material.

42. The table of claim 40, wherein said panel forms part of an apparatus for manipulating substantially block-shaped commodities and further comprising at least one conveyor arranged to carry out at least one of the functions of (a) supplying commodities to said panel and (b) receiving commodities from said panel.

43. A method of manipulating substantially block-shaped commodities, comprising the steps of:
advancing a series of successive commodities in a predetermined direction along a predetermined path;
interrupting the advancement of commodities in and upstream of a predetermined portion of said path; and
evacuating at least one commodity of said series from said portion of said path, including moving the at least one commodity in a direction and by at least one implement such that the advancement of commodities in said predetermined direction and beyond said predetermined portion of said path can be resumed immediately upon completion of evacuation of the at least one commodity from said portion of said path.

44. The method of claim 43, wherein said moving step includes lowering the at least one implement from a starting position into engagement with the at least one commodity in the predetermined portion of said path, and further comprising the step of raising the at least one implement to a level above the commodities in said predetermined portion of said path and returning the raised implement to said starting position.

45. The method of claim 43, wherein said evacuating step is carried out immediately upon start and in the course of said interrupting step.

46. The method of claim 43, wherein said moving step includes transferring the at least one commodity into a second path which is at least substantially parallel to said predetermined path.

47. The method of claim 43, further comprising the step of applying a force from above to the at least one commodity in the predetermined portion of said path.

48. The method of claim 47, further comprising the step of maintaining the application of said force only in the course of said evacuating step.

49. A method of manipulating substantially block-shaped commodities, comprising the steps of:
advancing a file of successive commodities in a predetermined direction along a first path;
interrupting the advancement of commodities in and upstream of a predetermined portion of the first path which portion is long enough to accommodate at least two successive commodities;
transferring the at least two successive commodities from said portion of the first path into a second path subsequent to initiation of said interrupting step; and
conveying the at least two successive commodities along said second path.

50. The method of claim 49, further comprising the step of resuming the advancement of commodities in said predetermined direction along said first path into and beyond said predetermined portion of said first path immediately upon completion of said transferring step.

51. The method of claim 49, wherein successive commodities of the file are immediately adjacent each other.

52. The method of claim 49, wherein said conveying step includes conveying the at least two successive commodities along said second path in said predetermined direction.

53. The method of claim 49, wherein said conveying step includes conveying the at least two successive commodities along said second path in a further direction at least substantially counter to said predetermined direction.

54. The method of claim 49, wherein the commodities are stacks of superimposed sheets.
